(19) United States
(12) Patent Application Publication
(10) Pub. No.: US 2016/0295661 A1
(43) Pub. Date: Oct. 6, 2016

(54) Custom Lighted Accessory

(71) Applicant: John Wink, Riverview, FL (US)

(72) Inventor: John Wink, Riverview, FL (US)

(21) Appl. No.: 14/675,213

(22) Filed: Mar. 31, 2015

(51) Int. Cl. H05B 37/02; F21V 33/00; H05B 33/08

(52) U.S. Cl. CPC H05B 37/029; H05B 33/086; H05B 33/0872; H05B 37/0272; F21V 33/0008

(57) ABSTRACT

A configurable system is provided for lighting operation and display with respect to an accessory article such as a purse or handbag. Decorative color-changing lights on an exterior surface of the article are driven by a controller within the article, wherein the controller is configured to interact with a remote computing device such as a user's Smartphone. In an embodiment, the system detects a color in an element of the user's environment, such as an article of clothing worn by the user, and controls the decorative color-changing lights in a manner coordinated with the element. In an embodiment, the system is implemented via an interactive application running on the Smartphone. In a further embodiment, the system also provides light within the article, e.g., to aid a user searching for an item.

### TECHNICAL FIELD

The disclosure pertains to apparel accessories, and more particularly pertains to a device and system for providing a customizable lighted accessory with selection assistance.

### BACKGROUND

As the devices we use in daily life continue to improve and become more technologically sophisticated, consumers have come to expect a similar level of functionality and sophistication in other more traditional areas. One example of this phenomenon is in the area of clothing and accessories; while clothing has been in existence for millennia in various forms, today's miniaturized electronics and LED technology make it possible to apply complementary lighting to personal accessories used with clothing, e.g., purses and handbags.

Even though lighting applied in such situations can result in an interesting novelty item a novel, the novelty would quickly wear off for the consumer since such lights would be static or changing in a way that is not customized to the user experience. Moreover, in the same way that some consumers need advice as to which clothing might look best, these same individuals would likely be disinclined or even unable to modify the lighting experience in a way that complements their wardrobe if such modification were offered.

While the present disclosure is directed to a system that may eliminate the shortcomings noted in this Background section, it should be appreciated that such benefits are not necessarily limitations on the scope of the disclosed principles or of the attached claims, except to the extent expressly recited in a claim. Additionally, the discussion of technology in this Background section is reflective of inventor observations or considerations, and is not intended to be admitted or assumed prior art as to the discussed details.

Moreover, the identification of the desirability of a certain course of action is the inventors' observation, and should not be assumed to be an art-recognized desirability. The citation of references is not intended to provide a broad and inclusive summary of the references, and nothing in the foregoing is intended to conclusively characterize any reference. Rather, only the references themselves are art, and this section is expressly disclaimed as art, prior or otherwise.

### SUMMARY OF THE DISCLOSURE

In an embodiment of the disclosed principles, a configurable system is provided for lighting operation and display with respect to an accessory article such as a purse or handbag. The term “bag” being hereafter used interchangeably to represent either item or similar items. The configurable system includes decorative color-changing lights on its exterior, driven by a controller configured to interact with a separate computing device. In an embodiment, the system detects a color in a user's environment and controls the decorative color-changing lights in a manner coordinated with one or more elements of the user's environment.

In an embodiment, the system is implemented via an interactive Smartphone application. The Smartphone application in this embodiment interacts with a controller associated with the decorative color-changing lights on the bag. In a further embodiment, the system also provides light within the article, e.g., to aid a user searching for an item in the bag. In a further embodiment, the application optionally provides one or more features including a color match function and a color recommendation function. The system may provide dynamic lighting options, e.g., LED color blinking, changing or flowing options.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a perspective schematic view of an article in accordance with embodiments of the disclosed principles;

FIG. 2 is a simplified view of an LED array usable in accordance with embodiments of the disclosed principles;

FIG. 3 is a circuit level schematic of a control circuit for implementing an embodiment of the disclosed principles; and

FIG. 4 is a flow chart illustrating a process for setting an accessory color panel in accordance with embodiments of the disclosed principles.

### DETAILED DESCRIPTION

As noted above, today's miniaturized electronics and LED technology make it possible to apply lighting to personal accessories such as purses and handbags. However, while this type of lighting can provide an interesting novelty, the use of lights that are static or changing in a way that is not customized to the user experience will not provide an entirely satisfactory experience. Even in systems where a user can provide some input as to the lighting characteristics, many users will remain unable to create a lighting experience that complements their wardrobe or surroundings.

The systems and principles described herein are able to ameliorate these shortcomings by providing a more intelligent and adaptable system for lighting operation and display. In particular, without discussing every nuance or variation at this point, the disclosure describes a purse or bag (the term “bag” being hereafter used interchangeably to represent either item) that includes decorative color-changing lights on its exterior, driven by a controller configured to interact with a separate computing device such as a user's smartphone or other device. In an embodiment, the processor is further configured to detect a user's clothing or surroundings and control the LEDs so as to coordinate their output through an interactive smartphone application.

In a further embodiment, the article includes externally-visible processor-controlled decorative LEDs on the outside, and these same LEDs also provide light within the article, e.g., to aid a user searching within their bag for an item such as a lighter or phone. A downloadable smartphone application is provided in an embodiment to allow the user to capture a photo or video image of their clothing or any specific clothing article or accessory article with which they desire to coordinate their bag lighting color.

In a further embodiment, the application optionally provides one or more features including the color match function described above, a color recommendation function that suggests a complimenting color, e.g., from a known designer or fashion figure, a color recommendation function that suggests a “wild” or clashing color, e.g., again from a known designer or fashion figure, as well as dynamic lighting options. The dynamic lighting options include, for example, LED color blinking or flowing options, as will be discussed in greater detail later below.

Turning now to the figures, wherein like reference numerals represent like elements, the disclosed principles are illustrated in the context of a bag 10, which may be a handbag, purse, satchel or other accessory having an external wall 11 defining an internal space 12 suitable for carrying one or more items (not shown). The bag 10 may also include one or more handles 13 by which a user may carry the bag.

In the illustrated embodiment, the external wall 11 of the bag 10 defines an external bag surface 14. In keeping with the disclosed principles, the external bag surface 14 has affixed thereon or therein a plurality of light-emitting elements 15. In an embodiment, the plurality of light-emitting elements 15 include multiple discrete LEDs. In an alternative embodiment, the light-emitting elements 15 are made of at least one light-emitting sheet, which has multiple regions thereon, each of which may display the same or different color as another region. In a further embodiment, the pattern of LEDs may also continue up along the straps or handles 13.

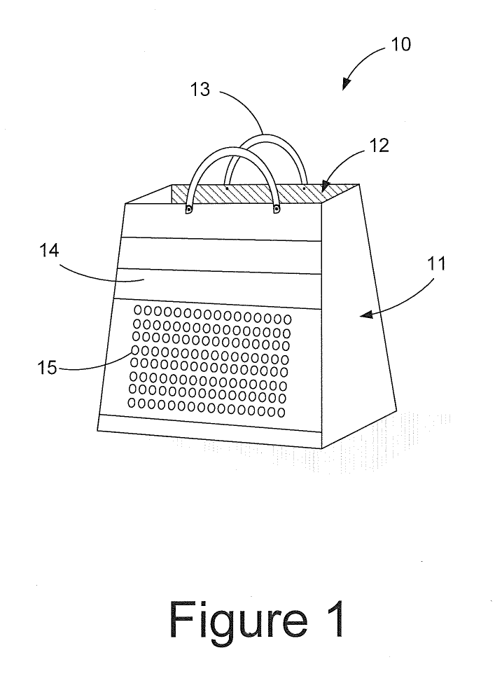

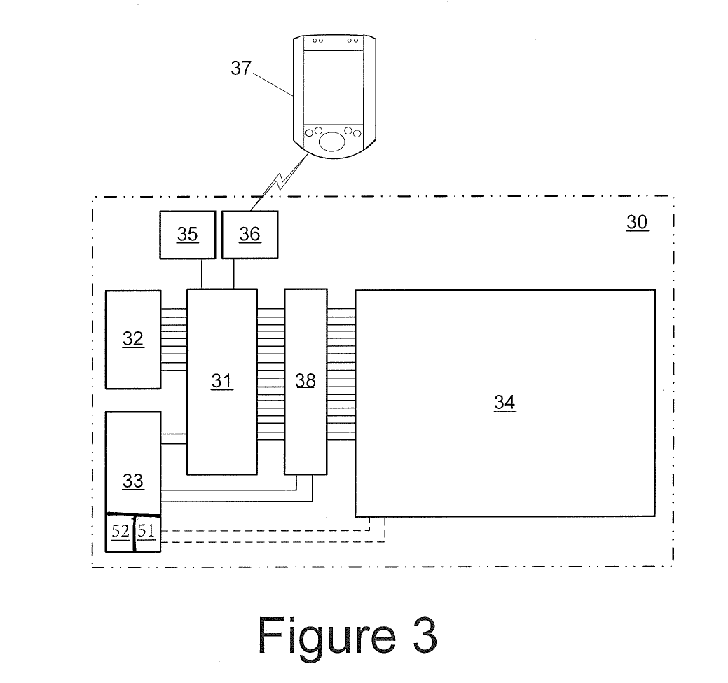

A controller is included within the bag 10, i.e., within the wall 11 or internal space 12. Although the controller is not visible in the view of FIG. 1, it will be discussed in greater detail later with reference to FIG. 3.

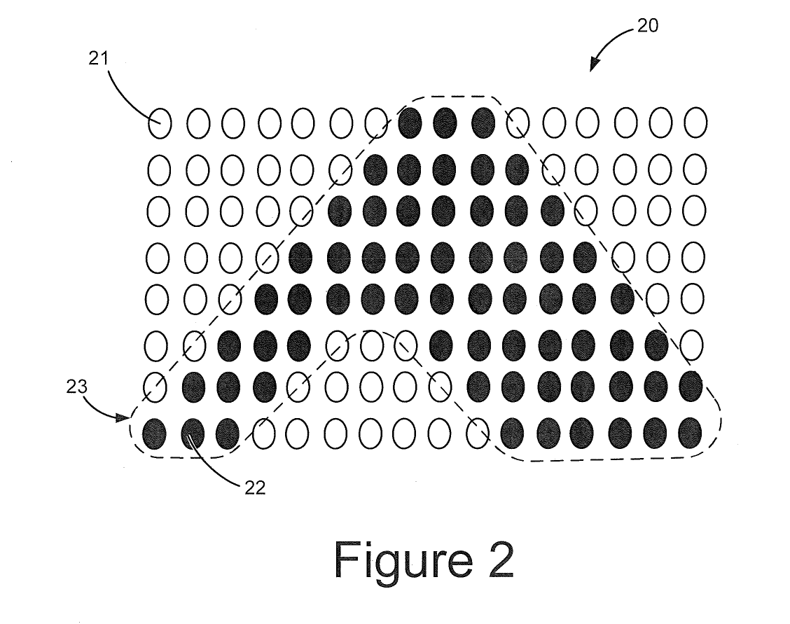

Turning to FIG. 2, an example LED array 20 is shown. Such an array may be used, for example, as the array of light-emitting elements 15 shown on the external bag surface 14 of the bag 10 in FIG. 1. In the illustrated example LED array 20, each LED is individually addressable, such that the controller is able to create light patterns such as pattern 23. In particular, the pattern 23 is created by the controller by setting certain LEDs 21 as off (or dim, or at a first color) and other LEDs 22 as on (or brighter, or at a second color). In this way, the pattern 23 can be seen on the outside of the bag 10.

It will be appreciated that any desired pattern of on and off or multi-colored LEDs can be created dynamically in this way. With respect to changing the color of an element, it will be appreciated that in embodiments that utilize multi-colored elements, these elements may be a combination of sub-elements. For example, a red LED, a green LED and a blue LED can be located closely together, with this 3-LED unit being repeated throughout the array. In this way, an array of “pixels” is created, with different strengths of the different LEDs at each pixel being controlled to set the color and brightness of the pixel.

It will be appreciated that the pixels of the array may be all or substantially all on, so as to create a solidly lit display. Within such a display, there may be static or dynamic color variations. This may be useful, for example, in an embodiment wherein the bag lighting actively adapts to mimic the appearance of a nearby surface such as clothes, drapes, walls and so on.

Also, as noted above in passing, the lighting system of the bag 10 may include an inwardly directed source of light shining into the interior 12 of the bag 10 to assist a user in viewing the bag's contents. The inwardly directed source of light may comprise one or more additional LEDs. In an alternative embodiment, the inwardly directed source of light is a reflection or emission from one or more of the LEDs 15 on the outside of the bag 10.

As noted above, a controller is hidden within the bag 10, either in the walls thereof 11 or the interior 12. The controller is part of a control circuit, which will be discussed in greater detail with reference to FIG. 3. In particular, FIG. 3 shows an exemplary control circuit architecture in schematic view.

The exemplary control circuit 30 includes primarily a controller 31. The controller 31 may be a microprocessor, microcontroller, or other integrated circuit, discrete circuit or combination of elements. The controller 31 typically includes memory resources used to execute computer-executable instructions or programs, but the control circuit 30 may include external memory resources 32 instead of or in addition to, any memory provided by the controller 31.

The control circuit 30 also includes a power source 33, which may be a battery, fuel cell, or other source of electrical power. The power source 33 serves both as a source of power for the other circuit elements of the control circuit 30 and as a source of power for the LEDs of the lighting array. The power source 33 is preferably rechargeable or otherwise renewable in order to allow long term use of the lighting system. Although the power source 33 is shown providing power through the controller 31, it will be appreciated that any suitable power distribution scheme may be used.

As can be seen from the illustrated example, the controller 31 addresses the LED array or panel 34. The number of lines needed to address the array 34 depends upon the size of the array 34 and the protocol used thereby. Moreover, in an embodiment, the array 34 includes logic for converting an input signal into a pixel location, brightness and color as well as one or more drivers to supply the needed current. In an embodiment wherein the controller 31 addresses a bare array 34 (one consisting only of lighting elements without accompanying logic or drivers), a current driver 38 may be provided by the controller 31 or between the controller 31 and the array 34.

In order to receive user input, a user interface 35 to the controller 31 may be provided. The user interface 35 allows the user to input preferences and control-related requests or other data or signals. For example, if the user wishes to change the device from an automatic mode to a manual mode, this may be accomplished via the user interface 35.

Similarly, a wireless interface 36 to a remote computing device 37 such as a Smartphone may be provided. In this way, the user can remotely control the device and the device can utilize the resources of the Smartphone 37 for its operations. For example, in an embodiment, a control application runs on the Smartphone 37 and uses the camera of the Smartphone 37 to capture visual data (outfit, surroundings, etc.). The communications facilities of the Smartphone 37 may also be leveraged by the controller 31 to receive updates, download the control application to the Smartphone 37 and so on.

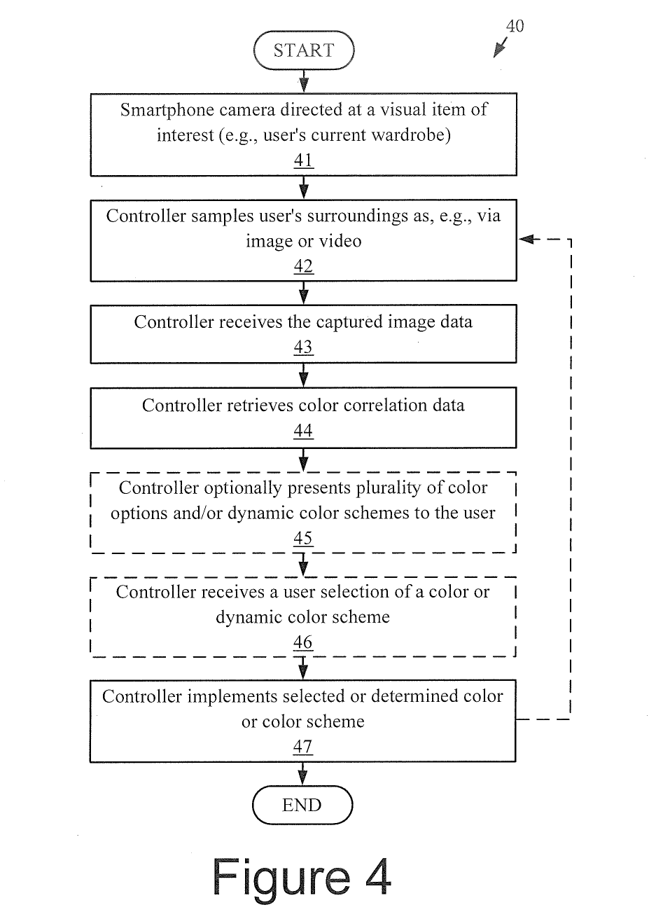

While the control process used by the controller may vary, the flowchart of FIG. 4 shows an example process 40 for controlling the LED array. The process 40 assumes an existing bag such as that shown in FIG. 1 having a control circuit such as that shown in FIG. 3. In this example, the control circuit has been configured to match the color of the LED array to the user's surroundings.

Since the matching process may be a single occurrence during a given use or may instead be a periodically updated occurrence during a single use, both options are discussed. Moreover, the process may be used both to provide a monolithic color surface or a color-patterned surface as will be discussed.

At stage 41 of the process 40, the user directs the Smartphone camera at a visual item of interest. For example, if the user wishes to have the controller set the LED array color by reference to the user's current wardrobe, then the user may direct the Smartphone camera at the wardrobe or wardrobe item in question. Similarly, if the user wishes to have the controller set the LED array color by reference to a wall surface, drape or other environmental element, then the user may direct the Smartphone camera at the environmental element the user desires to capture.

At stage 42 of the process 40, the controller samples the user's surroundings as appropriate, e.g., by capturing an image or video of the surface at which the Smartphone camera is directed. The capture process may occur once or may occur periodically as the process 40 is iterated. The controller receives the captured image data at stage 43.

With the image data in memory, the controller retrieves color correlation data at stage 44. Thus, for example, the if the user desires to simply match the sampled item or surface, the controller identifies a predominant color component in the captured image data as the correlated color. If instead the user desires that the bag be lit in a complementary color, the controller may look up a complementary color or colors in a table or, in an embodiment, may receive complementary color data from a remote source via the control circuit's connection to the user's Smartphone.

Similarly, if the user desires to employ a dynamic lighting pattern (changing in time), the controller may generate such a pattern or retrieve one from a remote data source. Such remote sources include, in various embodiments, a remote individual (e.g., a well-known fashion designer or industry personality), a remote periodically updated database, a remotely-hosted color selection process, and so on.

Subsequently at stage 45 of the process 40, the controller optionally presents a plurality of color options and/or dynamic color schemes to the user and receives, at stage 46, a user selection of a color or dynamic color scheme. Alternatively, the controller may simply determine and implement a color or dynamic color scheme determined to be best. With respect to the presentation of options to user and receiving a user selection, these steps are executed at the user's Smartphone in an embodiment. The color or scheme that has been selected or determined is then implemented by the controller at stage 47, and the process 40 may then terminate.

However, in an optional further embodiment, the controller provides the option of a continually updating color or dynamic scheme setting process, e.g., updating the color and/or dynamic pattern and/or brightness as the user's surroundings change. In this embodiment, if the user has indicated a desire for such a process, the process 40 returns to stage 42 from stage 47 to iterate and provide an update.

As noted above, the bag 10 preferably includes a power source 33 such as a battery, fuel cell, or other source of electrical power. In addition to serving as a source of power for the lighting array and other circuit elements of the control circuit 30, the power source 33 also serves, in an embodiment, as a source of power to run or recharge a user device. The user device may be, for example, a smartphone, tablet, or other personal data or communication device.

In this embodiment, the power source 33 includes or is connected to both a charging connection 51 and a recharging connection 52. The charging connection 51 is an input to the power source 33, allowing the power source 33 to be periodically recharged, and this element is preferably though not necessarily present in all embodiments. The recharging connection 52 is an output from the power source 33 and is adapted to be connected to the user's electronic device for recharging the device.

In this embodiment, the recharging connection 52 may be exposed inside of the bag 10 or outside of the bag 10. Of these, having the recharging connection 52 inside the bag 10 is preferred since such a configuration allows the user device to be carried in the bag 10 while the device recharges.

In a further embodiment, the handles 13 of the bag 10 also incorporate one or lighting elements, and may be partially or entirely covered by such elements. The handles may be lit differently from the surface of the bag 10 itself, or may be lit in a manner that complements or extends a lighting scheme used on the bag surface.

As noted above, the lighting elements may be separate LEDs, LED clusters, LED strips, or LED panels. Moreover, the lighting elements may be or include electroluminescent elements instead of or in addition to one or more other types of lighting elements.

As noted above, the lighting effects for the bag are driven by a controller within the article, wherein the controller is configured to interact with a remote computing device such as a user's Smartphone. However, in an alternative embodiment, the separate device may be connected to the controller via a wired connection, e.g., from within the bag 10.

It will be appreciated that systems and methods for improved accessory lighting have been disclosed. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

1. A configurable system for providing lighting on an exterior surface of a handbag, the system comprising:
a lightable panel comprising a plurality of lighting elements, each lighting element providing a selectable light color;
a control circuit associated with the lightable panel, the control circuit comprising:
a wireless communication module; and
a controller configured to communicate with a remote computing device via the wireless communication module in order to establish a lighting pattern for the lightable panel.

2. The configurable system in accordance with claim 1, wherein the remote computing device is a user smartphone device.

3. The configurable system in accordance with claim 1, wherein the plurality of lighting elements of the lightable panel are discrete LEDs.

4. The configurable system in accordance with claim 1, wherein each of the plurality of lighting elements of the lightable panel comprise three LEDs of mutually distinct colors.

5. The configurable system in accordance with claim 1, wherein the plurality of lighting elements of the lightable panel are regions of a continuous panel light.

6. The configurable system in accordance with claim 1, wherein the plurality of lighting elements of the lightable panel forms a static lighting pattern.

7. The configurable system in accordance with claim 6, wherein the static lighting pattern is a solid color selected based on an article of clothing of the user.

8. The configurable system in accordance with claim 1, wherein the plurality of lighting elements of the lightable panel forms a dynamic lighting pattern.

9. The configurable system in accordance with claim 8, wherein the dynamic lighting pattern changes based on an environment of the user.

10. The configurable system in accordance with claim 8, wherein the dynamic lighting pattern is a moving or changing pattern of light.

11. A configurable system for providing lighting on an exterior surface of a handbag, the system comprising:
a lightable panel providing a selectable light color pattern;
a control circuit associated with the lightable panel, the control circuit comprising:
a wireless communication module; and
a controller configured to communicate with a remote computing device via the wireless communication module in order to establish a lighting pattern for the lightable panel.
